(19) United States
(12) Patent Application Publication
(10) Pub. No.: US 2026/0070732 A1
(43) Pub. Date: Mar. 12, 2026

(54) BEVERAGE EXTRACTION SYSTEM

(71) Applicant: SOCIÉTÉ DES PRODUITS NESTLÉ S.A., Vevey (CH)

(72) Inventors: Aurélien TRULLARD, Jougne (FR); Emmanuel CROISIER, Lonay (CH); Nihan DOGAN, LA CROIX-s/LUTRY (CH); Matthieu BAUDOZ, Labergement Sainte Marie (FR)

(21) Appl. No.: 19/109,278

(22) PCT Filed: Sep. 7, 2023
(86) PCT No.: PCT/EP2023/074557

§ 371 Date: Mar. 6, 2025

(30) Foreign Application Priority Data
Sep. 12, 2022 (EP) 22195043.9

(51) Int. Cl. B65D 85/804; A47J 31/36

(52) U.S. Cl. CPC B65D 85/8046; A47J 31/3633

(57) ABSTRACT

The invention concerns a system comprising an extraction device of a beverage preparation machine and a pod, wherein—the pod comprises a pod body and a top lid, and—the extraction device comprises: —upstream and downstream pod enclosing parts relatively translatable between an open position for inserting and/or ejecting the pod and a closed position for forming an extraction chamber enclosing the pod during extraction, the downstream part comprising a downstream plane piercing arrangement for opening the lid of the pod, and wherein the body and the lid of the pod are made of a multilayer paper material comprising a layer of paper coated with at least a layer of plastic, and the external surface of the multilayer paper material of the top lid is covered by a layer presenting a surface tension inferior to 40 dyne/cm.

### FIELD OF THE INVENTION

The present invention relates to the field of preparation of beverages with a system including a single-serve container comprising a beverage ingredient and a machine that has an extraction chamber in which the container can be inserted and extracted.

### BACKGROUND OF THE INVENTION

Single serve containers for the automatic preparation of beverages encompass various formats of containers that can be relatively soft or flexible, such as pods, and made of any material, recyclable or non-recyclable, biodegradable or non-biodegradable, such as aluminium, plastic, filter paper.

WO 2020/089404 describes such a system extracting beverages from such soft or flexible pods. These pods present asymmetrical shape relatively to the plane comprising the flange of the pod. The extraction device is provided with an extraction chamber configured to adapt its size to the shape and volume of the pod introduced. The extraction chamber comprises:
an upstream part defining a cage and bearing an upstream piercing arrangement for opening the bottom wall of the pod and a liquid injector to supply liquid through the opened bottom wall, and
a downstream part defining a plate that comprises a downstream plane piercing arrangement for opening the lid of the pod.

During the process of extraction, water is supplied in the pod through the opened bottom wall which increases pressure inside the pod. The downstream plane piercing arrangement is designed for opening the lid by relative engagement with the lid under the effect of this rise in pressure of the injected liquid in the pod body chamber and inflation of the lid against the piercing arrangement.

In order to respect environment, it is required today to use pods made of biodegradable and/or compostable materials, in particular essentially made of paper. These new materials present to particular performances and lead to specific problems during the beverage preparation and the handling of the pod in the extraction device, in particular different mechanical properties before extraction and after extraction.

WO 2020/114995 and WO 2022/022899 describe such biodegradable pods made of paper and that can be used in the above described system. During coffee preparation, significant inconsistencies were observed in the quality of the coffee obtained from the same pods though these pods were exactly identical. In particular, it was noticed that the quality of the first coffee produced from the machine after a long period of non-use was different from the quality of the coffees subsequently produced after this first coffee.

An object of the invention is to address the above existing problem.

### SUMMARY OF THE INVENTION

Objects of the invention are achieved by the system comprising a beverage preparation machine and a pod according to claim 1, and the pod according to claim 10.

In a first aspect, there is provided a system comprising a beverage preparation machine and a pod containing a beverage ingredient,
wherein the pod comprises:
   a first and a second enclosing walls, said first and second pod enclosing walls defining a chamber for enclosing the beverage ingredient, wherein said first and second pod walls of the pod are made of a multilayer paper material, said material comprising a layer of paper assembled with at least a layer of plastic, preferably a compostable layer of plastic, and wherein said multilayer paper material is oriented so that said layer of plastic faces the internal part of the chamber of the pod, and
wherein the machine comprises an extraction device and this device comprises:
   upstream and downstream pod enclosing parts relatively translatable along a longitudinal axis between an open position for inserting and/or ejecting the pod and a closed position for forming an extraction chamber enclosing the pod during extraction,
   the upstream part bearing an upstream piercing arrangement for opening the first wall of the pod and a liquid injector,
   the downstream part comprising a downstream piercing arrangement for opening the second wall of the pod,
and
wherein in at least the second wall of the pod, the external surface of the multilayer paper material is covered by a protective layer, and
wherein the external surface of said protective layer presents a surface tension inferior to 40 dyne/cm, preferably inferior to 38 dyne/cm, even more preferably inferior to 36 dyne/cm.

The extraction device is typically comprised in a beverage preparation machine configured for receiving pods. For instance, the machine is a coffee, tea, chocolate or soup preparation machine, preferably a coffee machine. In particular, the machine is arranged for preparing within the extraction chamber a beverage by passing water, preferably hot, or another liquid through a pod containing an ingredient of the beverage to be prepared, such as roasted ground coffee or tea leaves or instant coffee or instant tea or chocolate or cacao or milk powder or dehydrated soup. In the preferred embodiment, the beverage ingredient is roasted and ground coffee.

The device is configured for extracting a beverage ingredient contained in a pod by supplying an extraction liquid such as water into the pod. The device comprises upstream and downstream pod enclosing parts relatively movable between an open position for inserting and/or ejecting such pod and a closed position for forming an extraction chamber enclosing the pod during beverage ingredient extraction.

Typically, the pod can be inserted into the device from above under the effect of gravity. Ejection or removal of the pod upon reopening of the enclosing parts may also be driven by gravity.

The upstream and downstream pod enclosing parts are relatively translatable along a longitudinal axis (XX′) between an open position for inserting and/or ejecting the pod and a closed position for forming an extraction chamber enclosing the pod during extraction.

The upstream part or injecting part comprises an upstream piercing arrangement in the form of one or more piercers for piercing the first wall of the inserted pod and at least one liquid injector for supplying liquid through the pierced first wall of the pod.

This upstream piercing arrangement can comprise piercers in the form of blades. These blades ca be designed and positioned to pierce the first wall of the pod body when the upstream and downstream pod enclosing parts are brought to the closed position. The liquid injector, such as a shower at the upstream part of the cage, can introduce the extracting liquid through the pre-pierced openings.

In an alternative, this upstream piercing arrangement can comprise at least one hollow needle configured to pierce the wall of the bottom of the pod body and the hollow needle(s) can comprise an internal axial channel for guiding the extracting liquid in the chamber of the pod.

The downstream part or dispensing part defines a plate transverse to the longitudinal axis. Accordingly, this plate extends along a plane that is perpendicular to the longitudinal axis XX′. This plate of the downstream part comprises a downstream plane piercing arrangement for opening the second wall of the pod when the extracting liquid is introduced inside the pod. Usually, this downstream plane piercing arrangement is designed for opening the second wall by relative engagement with the lid under the effect of the rise in pressure of the injected liquid in the chamber of the pod and inflation of the second wall against the piercing arrangement. This downstream plane piercing arrangement may comprise a rigid plate comprising opening elements like a plurality of relief and recessed elements such as spikes, that can present the shape of cones or pyramids, optionally truncated at their ends, on its surface turned to the second wall.

In addition, the plate comprises traversing holes to evacuate the beverage dispensed from the opened lid to a tube or nozzle collecting and dispensing beverage to a drinking cup.

Usually, the shapes of the upstream and enclosing parts of the extraction device are defined according to the shape of the pod configured to be extracted therefrom.

In a first embodiment of the system:
the pod is configured so that:
   the first enclosing wall is a pod body, said pod body comprising a side wall and a bottom wall defining the chamber and a circumferential annular body flange, said pod body containing the beverage ingredient, and
   the second enclosing wall is a top lid attached to the circumferential flange, said top lid closing the top opening of the pod body,
      and
the extraction device is configured so that:
   the upstream part defines a cage designed to enclose the pod body and bears an upstream piercing arrangement for opening the bottom wall of the pod,
   the downstream part defines a plate transverse to the longitudinal axis (XX′), said plate comprising a downstream piercing arrangement for opening the lid of the pod.

In this first embodiment, the pod presents an asymmetrical shape.

When a pod is present, the pod body is surrounded by the cage of the upstream part and the pod lid extends along the downstream piercing arrangement. The asymmetrical shape of the pod presents the advantage of forcing the operator to position the pod correctly inside the extraction device, precisely with the lid in front of the downstream piercing arrangement.

In a second embodiment of the system:
the pod is configured so that:
   each of the first and second enclosing walls is a pod body, said pod body comprising a side wall and a bottom wall defining half of the chamber and a circumferential annular body flange,
   the circumferential annular body flanges of said pod bodies are attached together, and
the extraction device is configured so that the upstream and downstream parts define together a cage for enclosing the pod.

In this second embodiment, generally, the upstream and downstream enclosing parts present similar shapes corresponding to said half-shells and the pod is symmetric along the plane defined by the flange. Accordingly, this pod can be indifferently oriented with the first enclosing all or the second enclosing wall facing the upstream pod enclosing part or the downstream enclosing part. For this reason, preferably both enclosing walls present the same nature of material as described below.

Generally, the extracting device can comprise an insertion section for inserting the pod in the device. Generally, this section is positioned above the upstream and downstream pod enclosing parts so that the pod is inserted by gravity between these two parts. Depending on the shape of the pod, this insertion section can be designed so that the user is urged to position the pod with its lid facing the downstream piercing arrangement.

Generally, this beverage machine comprises a liquid supply system connected to the upstream enclosing part. This liquid supply system can comprise:
a liquid supply such as a liquid tank,
pumping means to drive liquid from the liquid supply to the extraction device,
heating and/or cooling means to adapt the temperature of the liquid before it is introduced inside the pod.

The liquid is usually water.

This beverage machine usually comprises an actuator, either manual or motorized, to actuate the movement of the enclosing parts of the extraction device

Usually, this beverage machine comprises a control unit configured to control the supply of liquid to the extraction device and optionally the movement of the enclosing parts of the extraction device.

Usually, this system is configured to extract a coffee beverage from pod comprising roast and ground coffee. In this process of preparation of a coffee beverage from the system, at least the following steps occur:
the pod is inserted between the upstream and downstream pod enclosing parts that are positioned in their opened position. Usually, it is received in a pod holder that keeps it on the longitudinal axis (XX′) between the two pod enclosing parts which are hold far from each other in their opened positions.
then, the upstream and/or downstream pod enclosing parts are moved relatively one to the other to their closed position in order to form the extraction chamber that encloses the pod for the coming extraction. At that step, the external surfaces of the first and second walls of the pod are in contact with the surfaces of the upstream piercing arrangement and the downstream piercing arrangement. Due to the nature of the paper material of the pod, the presence of water on the surfaces of the upstream piercing arrangement and the downstream piercing arrangement can already impact the properties of the paper material at the moment where the upstream and/or downstream pod enclosing parts encloses the pod although extraction has not yet begun.
then, the extraction water is injected by the liquid injector through holes pierced inside the first wall of the pod by the upstream piercing arrangement. As water is being injected, it fills the chamber of the pod. Pressure rises until the second wall of the pod opens. Opening happens when the pressure makes the second wall inflate so much that its engagement with the downstream piercing arrangement tears or pierces it. Once tearing happens, coffee extracted by pressurised water from roast and ground coffee flows and is dispensed from the machine. Tearing shall not happen before the pressure rises inside the pod otherwise this pressure required for obtaining the desired extraction of coffee is not reached and under-extracted coffee beverage is dispensed. In addition, it is required that each pod opens at the same pressure and at the same time of the operation to get always the same aspect and sensory profile of the coffee beverage.

Depending on the nature of the lid, the surface of the lid of the pod can be come soggy when it contacts a wet downstream piercing arrangement. In that case, the pressure required to pierce the lid can become very high with a risk of not piercing at all the lid if the power of the pump is not sufficient.

In the present system, the first and second pod enclosing walls of the pod are made of a multilayer paper material that comprises a layer of paper assembled with at least a layer of plastic.

Preferably, all the components of the pod are compostable, in particular all the components of this multilayer paper material.

The layer of paper of this multilayer paper material can be a formable sheet of paper. Alternatively, and at least for the pod body, this layer of paper can be formed:
by wet pulp moulding. Therein, the process of forming the body may comprise the step of placing pulp slurry in a mould, for example by filling the mould with the slurry or by drowning the mould in the slurry. The pulp slurry may be pressed in the mould, and the so formed body may be dried. The pulp can be a material, such as cellulose pulp, bamboo pulp, wood pulp, bagasse, non-wood pulp, cellulose based pulp or other alternative sources of pulp in any form. or
by dry pulp moulding. Therein, the process of forming the body may comprise the step of providing a blank of preferably dried cellulose fibres. Then, the blank may be formed with a tool preferably under the application of heat and/or water into the shape of the body.

Preferably, the layer of paper of the multilayer paper presents a grammage of at least 20 g/m², preferably at most 150 g/m². The layer of paper forming the body can present a higher grammage than the layer of the paper forming the lid because it needs to be deformed during manufacturing.

The layer of paper of this multilayer paper material can also be identified as the primary layer in the present application.

Whatever the type of the layer of paper, this layer is assembled with at least a layer of plastic. This layer of plastic can also be identified as the secondary layer in the present application. The layer of plastic can be selected in the list of:
a polylactic acid (PLA) layer,
a polybutylene succinate (PBS) layer,
a polybutylene adipate terephthalate (PBAT) layer,
a polyhydroxy alkanoate (PHA) layer,
a polycaprolactone (PCL) layer,
a layer of a polymer blend formed of any combination of above polymers.

The paper layer can be assembled with several of these different layers of plastic.

This plastic layer reinforces the protection of the paper layer against liquid, gas and moisture for the beverage ingredient.

In addition to these paper and plastic layers, preferably, the multilayer paper material can comprise an additional layer of material providing a barrier to oxygen. This layer can also be identified as the tertiary layer in the present application.

This layer can be selected in the list of:
a polyvinyl-alcohol copolymer (PVOH) layer, in particular a butenediol-vinyl-alcohol-copolymer (BVOH) layer,
a polyglycolic acid (PGA) layer,
a metallization coating,
a SiOₓ based coating,
an AlOₓ based coating,
a combination thereof.

In one particular embodiment where this additional or tertiary layer is a plastic polymer, the secondary and tertiary layer can be assembled together as a multilayer plastic film. In this embodiment, this multilayer layer of plastic can comprise the internal tertiary layer positioned between two external secondary layers.

Preferably, the internal tertiary layer is a polyvinyl alcohol copolymer (PVOH) film, in particular a butenediol vinyl alcohol (BVOH) film.

Preferably, the external secondary polymer layers can be chosen among films of polylactic acid (PLA), polybutylene succinate (PBS), polyhydroxyalkanoates (PHA), polybutylene adipate terephthalate (PBAT) and starch. The secondary film can also be composed of a polymer blend formed of any combination of these listed polymers,

Preferably, these three layers are attached by means of two intermediate adhesive layers, preferably an anhydride modified polymer resin. Generally, this multilayer layer of plastic is produced by co-extrusion.

The multilayer paper material can further comprise an ink printing on one of its surfaces. The ink printing is preferably food safe.

The assembly of the different layers of the material can be obtained by any type of process depending on the nature of the layers such as:
co-lamination or co-extrusion of the layers,
coating or deposit of one compound on another layer to form a layer on the other,
co-extrusion coating.

In addition, the different layers can be bound one to the other by an intermediate adhesive layer.

Generally, the first and the second enclosing walls are made of the same multilayer paper material except that, at least for the second enclosing wall, the external surface of the multilayer paper material is covered by a protective layer. Depending on the type of pod, all the enclosing walls can be covered by this protective layer, this is particularly the case when the pod can be introduced in whatever orientation inside the extraction device, like for the second embodiment of the pod described above.

This protective layer can be:
a polylactic acid (PLA) layer,
a cellulosic layer (cellophane),
a polybutylene succinate (PBS) layer,
a polybutylene adipate terephthalate (PBAT) layer,
a polyhydroxy alkanoate (PHA) layer,
a polycaprolactone (PCL) layer,
a layer of a polymer blend formed of any combination of the above listed polymers.

Preferably, this protective layer is a film comprising regenerated cellulose, in particular Cellophane™

In addition, the external surface of this protective layer presents a surface tension inferior to 40 dyne/cm, preferably inferior to 38 dyne/cm, even more preferably inferior to 36 dyne/cm.

By external surface, it is meant the surface of the multilayer paper material that is external to the chamber of the pod, that is to say the surface of the pod that is in contact with the downstream piercing arrangement of the downstream pod enclosing parts of the extraction device during the beverage preparation.

This surface tension of the external surface of the protective layer is measured by the method based on contact angle measurement according to norm ISO 19403-2:2017.

An external surface of the lid with a low surface tension such as defined above avoids any difference of quality in the preparation of a beverage, in particular coffee, between a first beverage prepared with the extraction device used for the first time of the day (and implicitly dry) and a second beverage prepared with the extraction device used prepared just after the first beverage (and implicitly wet).

In a second aspect, there is provided a pod for preparing a beverage in a beverage preparation machine, wherein the pod comprises a first and a second enclosing walls, said pod enclosing walls defining a chamber, said chamber containing a beverage ingredient,
wherein said first and the second pod enclosing walls of the pod are made of a multilayer paper material, said material comprising a layer of paper assembled with at least a layer of plastic, preferably a compostable layer of plastic, and
wherein said multilayer paper material is oriented so that said layer of plastic faces the internal part of the chamber of the pod,
and
wherein in at least the second pod enclosing wall, the external surface of the multilayer paper material is covered by a protective layer, and
wherein the external surface of said protective layer presents a surface tension inferior to 40 dyne/cm, preferably inferior to 38 dyne/cm, even more preferably inferior to 36 dyne/cm.

In the present application:
the term “pod” is used to broadly designate any kind of single-dose container suitable for preparing beverages or other edible products such as capsule, cartridge, portioned or individual package without limitation to the shape of this container, in particular the shape of the body, or the types of piercing means needed to extract the beverage therefrom.
the expression “compostable material” may be understood as any material that can be broken down into environmentally innocuous products by (the action of) living things (such as microorganisms, e.g. bacteria, fungi or algae). This process could take place in an environment with the presence of oxygen (aerobic) and/or otherwise without presence of oxygen (anaerobic). This may be understood, for example, as meaning that composting can be carried out without reservation. In particular, at the end of a composting process there are no residues of the material, which may be problematic for the environment, or any non-biodegradable components.

International standards, e.g. EU 13432 or US ASTM D6400, specify technical requirements and procedures for determining compostability of a material.

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### BRIEF DESCRIPTION OF THE DRAWINGS

Specific embodiments of the invention are now described further, by way of example, with reference to the following drawings in which:

FIGS. 1A and 1B are views of pods used in the system of the present invention according to a first embodiment,

FIGS. 1C and 1D are views of pods used in the system of the present invention according to a second embodiment,

FIG. 1E schematically illustrates the multilayer paper material of the pods,

FIGS. 2A and 2B are side and top views of an extraction device used in the system of the present invention in the closed position,

FIG. 3A is an isolated side view of the upstream and downstream pod enclosing parts of the extraction device in the opened position,

FIG. 3B is an isolated side view of the upstream and downstream pod enclosing parts of FIG. 3A in the closed position,

FIG. 3C is an isolated side view of the upstream and downstream pod enclosing parts of FIG. 3A in the position of ejection of the pod,

FIG. 4A is an isolated perspective view of the upstream pod enclosing part of FIG. 3A,

FIG. 4B is an isolated perspective view of the piercing arrangement of the downstream pod enclosing part of FIG. 3A,

FIG. 5 is a magnified view of the opening elements of the piercing arrangement of FIG. 4B.

FIG. 6 is a schematic view of the fluid system of the beverage preparation machine,

FIG. 7 are curves of water pressure measured in the system during beverage preparation with different pods.

### DETAILED DESCRIPTION OF EXEMPLARY EMBODIMENTS

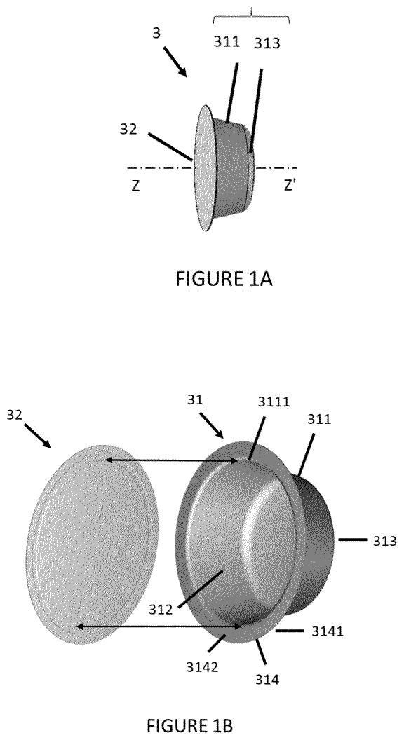

FIG. 1A (perspective view) and 1B (exploded view) illustrate a first embodiment of the pods 3 that can be used in the extraction device of the invention.

The pod 3 comprises a pod body 31 with one sidewall 311 that extends axially from a bottom wall 313 towards a top. The sidewall 311 extends towards a top opening 312. At the top opening 312, the body comprises a circumferential annular flange 314 that extends radially outward from the sidewall 311 along the circumference of the opening 312.

The flange comprises a top surface 3142 facing the top and a bottom surface 3141.

Generally, any transversal cross section of the body is circular from the bottom to the top and the flange is circular too.

The body delimits a chamber for containing a beverage ingredient.

This beverage ingredient packed is preferably an ingredient able to be extracted under pressure like roast and ground coffee.

In a less preferred manner, the beverage ingredient can be infused like tea leaves or dissolved like a water soluble powder ingredient such as: instant coffee powder, milk powder, cream powder, instant tea powder, cocoa powder, soup powder, fruit powder or mixture of said powders or even a soluble liquid ingredient or a beverage concentrate such as a syrup or milk concentrate.

The powders can be compacted, agglomerated or sintered.

The capsule comprises a lid 32 that is fixed, sealed or attached to at least a part of the top surface 3142 of the circumferential flange and accordingly covers and closes the top opening 312.

The bottom wall 313 is adapted to be pierced so that liquid can be injected in the pod through the pierced openings, as described further below. In FIGS. 1A-B, this bottom is rather flat, yet the bottom can present other shapes such conical ore frustoconical shapes.

The lid 32 is adapted to be opened by relative engagement with a piercing arrangement under the effect of the liquid pressure increase inside the pod during injection of liquid.

The pod shape is symmetric relatively to the central axial axis ZZ′ extending from the bottom wall to the lid and the pod shape is asymmetrical relatively to the plane of the lid 32 and the flange 314.

Preferably the pods 3 are essentially made of a biodegradable or compostable material, preferably a home compostable material since extracted coffee cakes can easily be made composted at home.

Preferably, the body and the lid of the pod are made of a multilayer paper material, that comprises a layer of paper coated with at least a layer of plastic.

In this multilayer paper material, the paper layer is formable, i.e. a sheet of paper can be given a three-dimensional shape that is the form of the body of the above described pod. Contrary to common pods made of filter paper, this paper is thick and keep the three-dimensional shape provided during a shaping step of manufacturing of the pod.

Preferably, the paper layer of the pod can have a grammage of at least 20 g/m², preferably at most 150 g/m². The paper of the body can present a higher grammage than the paper of the lid because it needs to be deformed during manufacturing.

The grammage of the paper of the body can be comprised between 80 and 150 g/m². The lid can present a grammage comprised between 20 and 120 g/m².

In the multilayer paper material, the layer of plastic provides additional properties such as air barrier, stretchable or deformable properties, for example as described in WO 2020/114995 or WO 2022/022899.

In fact, in order to shape the paper as a container for the beverage and to create a barrier to protect the beverage ingredient, the paper must be sufficiently thick. In addition, to create a barrier to atmosphere, in particular oxygen to which roast and ground coffee is particularly sensitive, the multiplayer paper comprises compostable layers of plastic. Sealants layers are often necessary to attach the different layers and prevent delamination.

According to the preferred embodiment, the layer of plastic of the multilayer paper is a multilayer layer of plastic comprising an internal barrier film positioned between two external polymer films, wherein:
the internal barrier film is a butenediol vinyl alcohol (BVOH) film (tertiary layer),
the external polymer films can be chosen among films of polylactic acid (PLA), polybutylene succinate (PBS), polyhydroxyalkanoates (PHA), polybutylene adipate terephthalate (PBAT) and starch (secondary layer).

The multilayer paper material of the lid comprises at least one additional layer that the paper material of the body does not necessary comprise. Yet, it is possible that the multilayer paper materials of the lid and the body are the same too.

Precisely, the external surface of the multilayer paper material of the top lid is covered by a protective layer such that the external surface of the lid presents a surface tension inferior to 40 dyne/cm, preferably inferior to 38 dyne/cm, even more inferior to 36 dyne/cm.

According to the preferred embodiment, this protective layer is a film comprising regenerated cellulose.

FIG. 1E schematically illustrates the multilayer paper of the lid 32 comprising from the internal surface facing the chamber to the external surface facing the outside of the pod:
a layer of plastic B with barrier properties,
a layer of plastic A,
a protective layer C.

FIG. 1C (perspective view) and 1D (exploded view) illustrate a second embodiment of the pods 3 that can be used in the extraction device of the invention.

The pod comprises the first and second enclosing walls 31, 31′ that are identical: each of them comprise is a pod body 311, 311′, said pod body defining half of the chamber and a circumferential annular body flange 314,314′, and
the circumferential annular body flanges of said pod bodies are attached together so as to delimit a chamber for containing the beverage ingredient 33.

With this second embodiment, the pod shape is symmetric relatively to the central axial axis ZZ′ extending from the bottom wall to the lid and relatively to the plane of the attached flanges 314, 314′. Consequently, the pod can be indifferently oriented inside the extraction device with the first enclosing all 31 or the second enclosing wall 31′ facing the upstream pod enclosing part. For this reason, it is preferable that both enclosing parts 31, 31′ present the same the multilayer paper material with the external surface covered by the protective layer C as illustrated in FIG. 1E.

Below description relates to an extraction device that can be used with the above pods 3 according to the first embodiment of FIG. 1A, 1B in an advantageous manner.

For the pods according to the second embodiment, below description applies with the difference that the extraction device must be adapted to receive such pods. For example, the extraction device described in WO2007/135135, WO2004/071259, WO2013026844 or EP1767129 can be used.

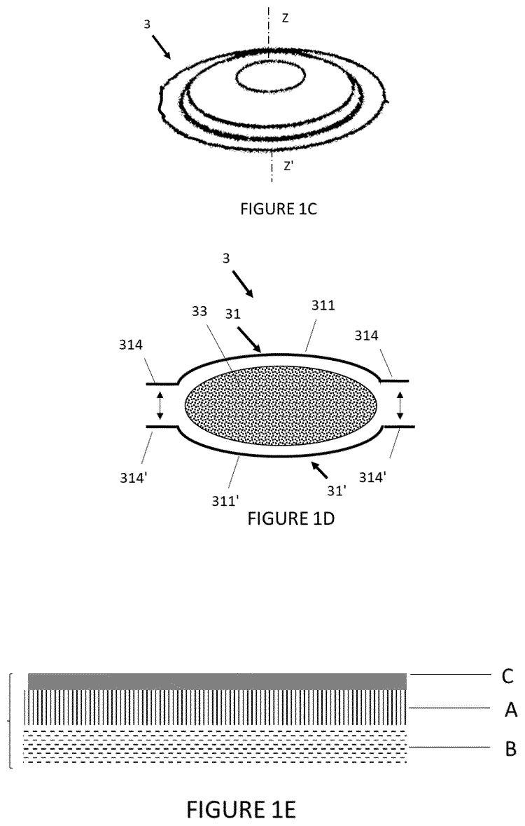

FIG. 2A is a side view of an extraction device according to the invention comprising an upstream pod enclosing part 2 and a downstream pod enclosing part 1 relatively translatable along a longitudinal axis XX′. Usually, this axis XX′ is essentially horizontal. In FIG. 2A, these two parts are in a closed position and form an extraction chamber configured to enclose a pod during extraction. The pod is introduced through an insertion section 4 positioned above the two enclosing parts 1, 2, from which it can fall by gravity to these two enclosing parts 1, 2. After extraction, the pod can fall by gravity again below these two enclosing parts 1, 2 when they move apart one from the other. The arrow F illustrates the movement of the pod from the insertion inside the extraction device to the ejection from said device.

The two pod enclosing parts 1, 2 are hold and movable between two lateral and longitudinal metal sheets 6a, 6b. At least one of these parts is movable in translation between these two sheets in order to assess different relative and functional positions. In the preferred illustrated embodiments, the downstream enclosing part 1 is fixed and only the upstream enclosing part 2 is movable back and forth along the longitudinal axis XX′.

FIG. 2B is a top view of the extraction device in the same relative positions of the upstream pod enclosing part 2 and the downstream pod enclosing part 1. The insertion section 4, in particular its housing, is designed to enable the introduction of the pod 2 with its lid 32 facing the downstream pod enclosing part 1 and accordingly the piercing arrangement 12 of said enclosing part as developed below. Consequently, the user is urged to position correctly the asymmetric pod 3 inside the extraction device.

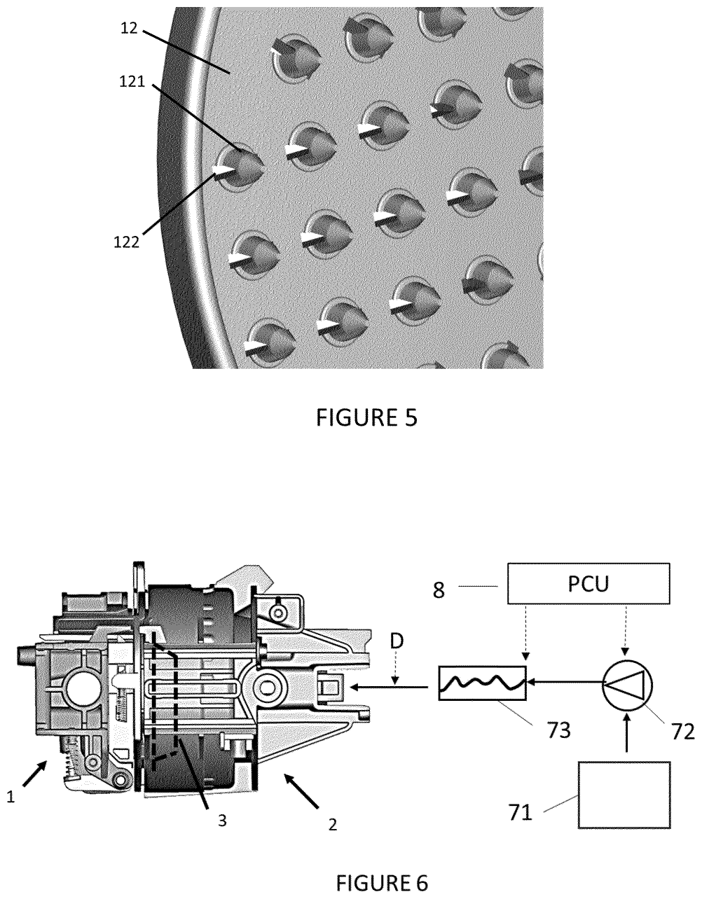

As illustrated in FIG. 6, in the beverage preparation machine that comprises the extraction device, the upstream pod enclosing part, precisely the liquid injector 25, is connected with a supply of liquid, preferably pressurised water. This liquid supply system usually comprises:
a liquid supply such as a liquid tank 74,
a pump 72 to drive liquid from the liquid supply to the liquid injector 25,
heating and/or cooling means 73 to adapt the temperature of the liquid before it is introduced inside the pod by the liquid injector.

This beverage machine comprises a control unit 8 configured to the supply of liquid to the extraction device.

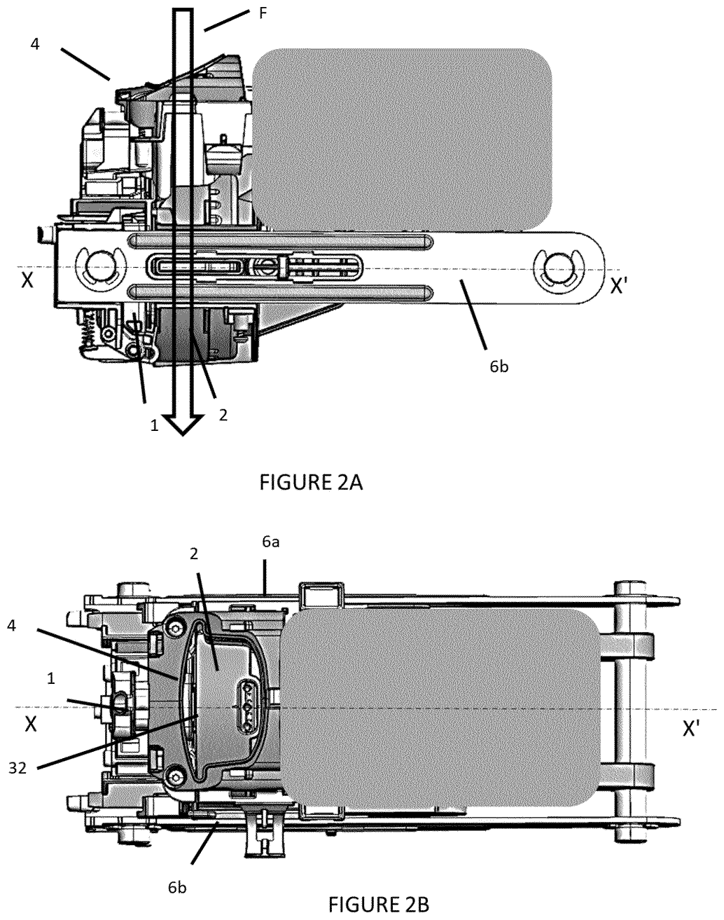

FIGS. 3A-3C are isolated side views of the upstream and downstream pod enclosing parts 1, 2 of the extraction device of FIGS. 2A, 2B in different relative and functional positions. In these isolated views, the insertion section 4 and the longitudinal sheets 6a, 6b were removed for a better vision of the different elements of the parts 1, 2. In addition, the position of the pod 3 is schematically illustrated in dotted lines.

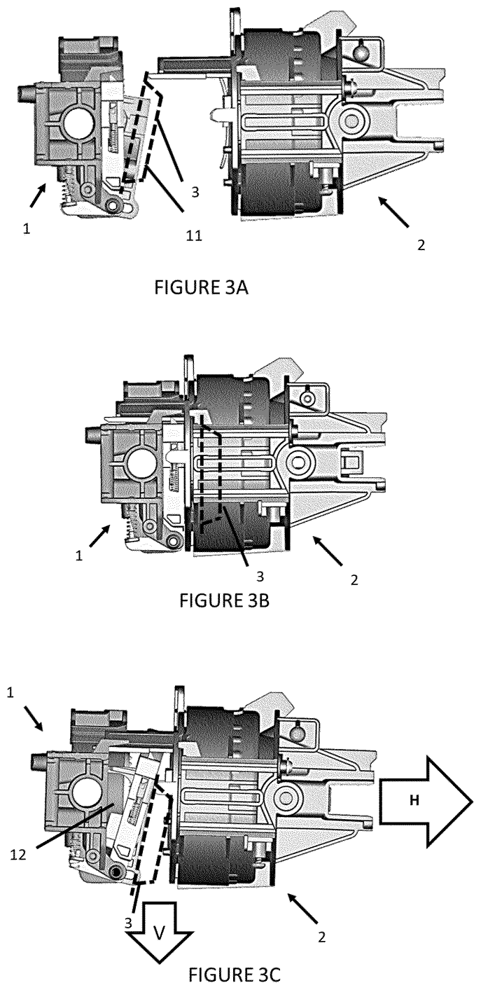

In FIG. 3A, the upstream and downstream pod enclosing parts 1, 2 are positioned in the open position for inserting a pod from the upper side. A pod holder 11 is visible in front of the downstream pod enclosing part 1 in a receiving position for receiving and holding the pod as further described below in relation with FIG. 4A.

In FIG. 3B, the upstream and downstream pod enclosing parts 1, 2 are positioned in the closed position and form an extraction chamber enclosing a pod during extraction.

FIG. 3C illustrates the moment where the upstream pod enclosing part 2 is being moving from the closed position of FIG. 3B to a pod ejection position as showed by arrow H.

FIG. 4A is an isolated perspective view of the upstream pod enclosing part 2 of FIGS. 3A and 3B.

The upstream part defines an empty cage or cavity 21 for enclosing the pod body.

The upstream wall of the cage bears an upstream piercing arrangement 22 for opening the bottom wall 313 of the pod body. The upstream wall comprises at least one liquid injector 25 for supplying liquid into the pod through the holes opened in the bottom wall of the pod.

This upstream piercing arrangement can comprise piercers in the form of blades. These blades can be designed and positioned to pierce the wall of the bottom of the pod body when the upstream and downstream pod enclosing parts are brought to the closed position as in FIG. 3B. The liquid injector 25, such as a shower at the upstream wall of the cage, can introduce the extracting liquid in the cage and through the pre-pierced openings.

FIG. 4B is an isolated perspective view of the downstream pod enclosing part 2 of FIG. 3A. The downstream part 1 defines a plate perpendicular (that is transverse) to the longitudinal axis XX′. This plate comprises a fixed central downstream plane piercing arrangement 12 for opening the lid 32 of the pod when the extracting liquid is introduced inside the pod and inflates the lid.

Usually, this central downstream plane piercing arrangement 12 is circular like the lid of the pod.

Opening happens by relative engagement of spikes with the lid under the effect of the rise in pressure of the injected liquid in the pod body chamber. This downstream plane piercing arrangement may comprise a rigid plate comprising opening elements 121 such as spikes, that can present the shape of cones or pyramids, optionally truncated at their ends, on its surface turned to the lid. In addition, the plate comprises traversing holes to evacuate the beverage dispensed from the opened lid to a tube or nozzle collecting and dispensing beverage to a drinking cup.

The downstream part 1 comprises a pod holder 11 that is attached to the peripheral area 13.

While being attached the pod holder can be moved between two positions. In FIG. 4B, the pod holder 11 is in the first position for receiving and holding the lid of the pod in front of the downstream plane piercing arrangement.

The pair of retaining elements 11a, 11b are movable from the receiving position to a second retracted position at the lateral sides of the downstream plane piercing arrangement.

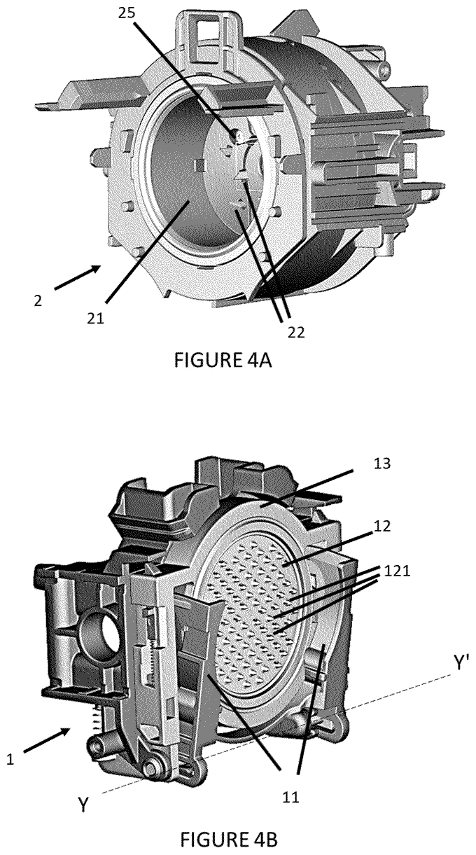

FIG. 5 is a magnified view of the plate 12 and the opening elements 121 of the downstream plane piercing arrangement. The traversing holes 122 are designed so that their upstream ends-provided at the side of the plate that faces the pod—are provided in a part of the opening elements 121. In the preferred illustrated embodiment, the opening elements 121 are cones with sharp ends and the upstream ends of the traversing holes extend from the bottoms of the cones along a part of the lateral faces of said cones.

This design of the upstream ends of the holes is preferred when the multilayer paper of the lid is thick since it is a guarantee that the holes are not blocked by the thick paper material and that the extracted coffee can be dispensed through the holes 122.

Yet with other multilayer papers, other types of opening elements 121 of the downstream plane piercing arrangement can be implemented, like truncated pyramids.

### EXAMPLES

Different coffee pods 3 according to FIGS. 1A, 1B and containing 8.8 g of roast and ground coffee were manufactured with lids 32 of different materials and then extracted in a beverage preparation machine comprising an extraction device such as illustrated in FIGS. 2A-5.

The multilayer paper material of the bodies 31 of the pods presented a thickness of 195 μm and comprised:
an external layer of paper, and
an internal plastic layer comprising an internal barrier film positioned between two external polymer films, wherein:
   the internal barrier film was a sheet of BVOH (Nichigo G-Polymer™ supplied by Nippon Goshei), and
   both external polymer films were of the same nature and were polymer blends of polylactic acid (PLA), polybutylene succinate (PBS) and polybutylene adipate terephthalate (PBAT) (Ecovio® 40 FS23N1 supplied by BASF).

The bodies of all the pods were made of the same above material. But the material of the lids of the pods differed as explained below.

The multilayer paper materials of the lids 32 of the pods presented a thickness of about 165 μm and comprised:
an internal plastic layer B identical to the internal plastic layer used for the pod body,
an intermediate layer of paper A presenting a lower thickness than the layer of paper used in the body multilayer paper material, and
one external protective layer C selected in one of the layers of Table 1.

In Table 1, the composition and the surface tension of the surface of the layer C that is oriented at the outside of the pod are indicated.

All the listed protective layers were supplied by Futamura company and differ one from the other by a surface treatment providing different surface tension values.

TABLE 1

| | | Surface tension |
|---|---|---|
| | | (dyne/cm) of the layer |
| | | face positioned at |
| Commercial name of | | the external |
| the protective layer | Composition | face of the lid |
| Cellophane 23NE | regenerated cellulose | 32 |
| Cellophane LMS | regenerated cellulose | 34 |
| Cellophane P00 | regenerated cellulose | 58 |
| PBS | PBS film | 42 |

The different coffee pods were extracted with 110 ml of hot water at 78° C. and supplied at a pressure between 10 and 12 bars.

For each types of pods,
a first series of 10 coffee beverages was made with the downstream opening arrangement 12 dry and cold as it is the case when the extraction device has not been used for a certain time (the internal parts of the extraction chamber were dried between each beverage preparation), and
a second series of 10 coffee beverages was made just after the first series and accordingly using the extraction device with the downstream opening arrangement 12 still wetted by the precedent coffee preparation.

The quality of the two series of coffee beverages were analysed and compared for each type of pods and the results are summarised in Table 2. The quality was objectively analysed by measuring during each extraction:
the pressure of water measured inside the fluid system, and deducing the maximal pressure, during the extraction process, and
the flowtime of coffee from the extraction device.

These measures of maximal pressure and flow time of the first series were compared to the measures obtained during the second series by calculating ΔPₘₐₓ and Δflowtime.

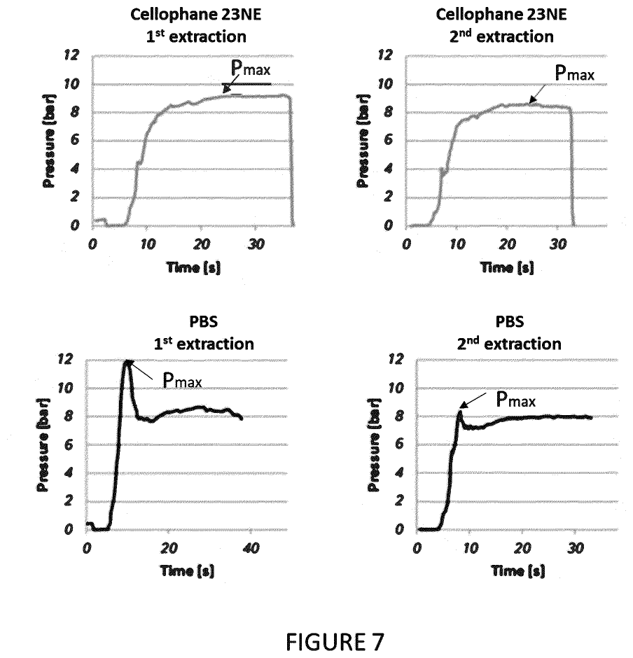

The pressure was measured at a place of the fluid supply system that was downstream the pump 72 and upstream the liquid injector 25 such as the point D illustrated in FIG. 6. FIG. 7 illustrates the curves of pressures measured during coffee extraction and how the maximal pressure Pₘₐₓ was identified in the curve.

The flow time was measured by detecting the first drop of coffee in a container positioned on a connected scale until 110 grams of coffee beverages was measured.

These measures are presented in Table 2 for each type of pod.

Depending on the nature of the protective layer at the external surface of the lid, significant differences in these measures established differences of quality in the coffee beverages produced by the machine. Such an inconsistency is not acceptable from an automatic beverage system.

TABLE 2

| | | | | Presence of a | |
|---|---|---|---|---|---|
| | | | | peak of | Difference in quality |
| External | Surface | | Δflow- | pressure at | of prepared coffees at |
| protective layer | tension | ΔPₘₐₓ | time | the beginning | the 1^{st} series compared |
| of the pod lid | (dyne/cm) | (bar) | (s) | in 2^{nd} series | to the 2^{nd} series |
| Cellophane 23NE | 32 | +0.6 | +0.6 | No | no significant difference |
| Cellophane LMS | 34 | +0.1 | +0.1 | No | no significant difference |
| Cellophane P00 | 58 | +1.7 | +2.2 | Yes | significant difference |
| PBS | 42 | +1.6 | +2.4 | Yes | significant difference |

In particular, the curves of pressures measured during the second series of coffee extraction showed that with an external protective layer of the pod lid surface presenting a surface tension above 40 dyne/cm, an important peak of pressure Po happened at the beginning of the extraction. In FIG. 7B, this peak rises up to 12 bars. This peak is due to the pod surface becoming soggy after the closure of the extraction chamber and the contact if this surface with the wet piercing arrangement.

In addition to the impact on the difference of extraction between the first and the second series of coffee beverages, the presence of the peak of pressure at the beginning of the extraction increases the risk of extraction defect like blocking of the holes configured to evacuate the coffee beverage and beverage not coming out properly.

These examples confirm that the choice of a protective layer with an external surface that presents a surface tension inferior to 40 dyne/cm avoids inconsistent quality of coffee beverages whatever the moment of the preparation of these coffees, meaning independently of the fact that it is the first coffee of the day or the following one.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

List of references in the drawings:

| | |
|---|---|
| downstream enclosing part | 1 |
| pod holder | 11 |
| downstream plate piercing arrangement | 12 |
| spikes | 121 |
| peripheral area | 13 |
| chassis | 14 |
| upstream enclosing part | 2 |
| cage | 21 |
| upstream piercing arrangement | 22 |
| liquid injector | 25 |
| pod | 3 |
| body | 31, 31′ |
| side wall | 311 |
| top end | 3111 |
| top opening | 312 |
| bottom wall | 313 |
| flange | 314, 314′ |
| top face | 3141 |
| bottom face | 3142 |
| lid | 32 |
| ingredient | 33 |
| insertion section | 4 |
| extraction chamber | 5 |
| lateral sheet | 6a, 6b |
| tank | 71 |
| pump | 72 |
| heater | 73 |
| control unit | 8 |

1. A system comprising a beverage preparation machine and a pod containing a beverage ingredient,
wherein the pod comprises first and second enclosing walls, the first and second pod enclosing walls defining a chamber for enclosing the beverage ingredient,
wherein the first and second enclosing walls of the pod are made of a multilayer paper material, the material comprising a layer of paper assembled with at least a layer of plastic,
wherein the multilayer paper material is oriented so that the layer of plastic faces an internal part of the chamber of the pod,
wherein the beverage preparation machine comprises an extraction device, and the extraction device comprises:
upstream and downstream pod enclosing parts relatively translatable along a longitudinal axis between an open position for inserting and/or ejecting the pod and a closed position for forming an extraction chamber enclosing the pod during extraction,
the upstream pod enclosing part bearing an upstream piercing arrangement for opening the first enclosing wall of the pod, and the upstream pod enclosing part further comprising a liquid injector,
the downstream pod enclosing part comprising a downstream piercing arrangement for opening the second enclosing wall of the pod,
wherein an external surface of the multilayer paper material is covered by a protective layer in at least the second pod enclosing wall,
wherein an external surface of the protective layer has a surface tension inferior to 40 dyne/cm.

2. The system according to claim 1, wherein the downstream plane piercing arrangement for opening the second enclosing wall of the pod comprises a rigid plate, and wherein:
a surface of the rigid plate is turned to the second enclosing wall of the pod and comprises opening elements,
the rigid plate comprises traversing holes to evacuate the beverage dispensed from the opened second enclosing wall.

3. The system according to claim 1, wherein the layer of plastic is selected from the group consisting of:
a polylactic acid layer,
a polybutylene succinate layer,
a polybutylene adipate terephthalate layer,
a polyhydroxy alkanoate layer,
a polycaprolactone layer, and
a layer of a polymer blend formed of any combination of above polymers.

4. The system according to claim 1, wherein the multilayer paper material comprises an additional layer, the additional layer selected from the group consisting of:
a polyvinyl-alcohol copolymer (PVOH) layer,
a polyglycolic acid layer,
a metallization coating,
a SiOₓ based coating,
an AlOₓ based coating, and
a combination thereof.

5. The system according to claim 4, wherein the additional layer is a plastic polymer, and the layer of plastic comprises the additional layer positioned between two external layers selected from the group consisting of films of polylactic acid, polybutylene succinate, polyhydroxyalkanoates, polybutylene adipate terephthalate, starch, and any film of a polymer blend formed of any combination of the polymers.

6. The system according to claim 1, wherein the protective layer is a film comprising regenerated cellulose.

7. The system according to claim 1, wherein the beverage ingredient contained in the pod is roast and ground coffee.

8. The system according to claim 1, wherein:
in the pod:
the first enclosing wall is a pod body, the pod body comprising a side wall and a bottom wall defining the chamber and a circumferential annular body flange, the pod body containing the beverage ingredient, and
the second enclosing wall is a top lid attached to the circumferential flange, the top lid closing a top opening of the pod body, and
in the extraction device:
the upstream pod enclosing part defines a cage defines a cage designed to enclose the pod body and bears an upstream piercing arrangement for opening the bottom wall of the pod,
the downstream pod enclosing part defines a plate transverse to the longitudinal axis, the plate comprising a downstream piercing arrangement for opening the top lid of the pod.

9. The system according to claim 1, wherein:
in the pod:
each of the first and second enclosing walls is a pod body, the pod body comprising a side wall and a bottom wall defining half of the chamber and a circumferential annular body flange, and
the circumferential annular body flanges of the said pod bodies are attached together, and
in the extraction device, the upstream and downstream pod enclosing parts define a cage for enclosing the pod, and
wherein in each of the first and second pod enclosing parts, the external surface of the multilayer paper material of the pod enclosing part is covered by the protective layer presenting the surface tension inferior to 40 dyne/cm.

10. A pod for preparing a beverage in a beverage preparation machine, wherein the pod comprises first and second pod enclosing walls, the first and second pod enclosing walls defining a chamber, the chamber containing a beverage ingredient,
wherein the first and the second pod enclosing walls of the pod are made of a multilayer paper material, the multilayer paper material comprising a layer of paper assembled with at least a layer of plastic,
wherein the multilayer paper material is oriented so that the layer of plastic faces an internal part of the chamber of the pod,
wherein an external surface of the multilayer paper material is covered by a protective layer in at least the second pod enclosing wall,
wherein an external surface of the protective layer has a surface tension inferior to 40 dyne/cm.

11. The pod according to claim 10, wherein the layer of plastic is selected from the group consisting of:
a polylactic acid layer,
a polybutylene succinate layer,
a polybutylene adipate terephthalate layer,
a polyhydroxyalkanoate layer,
a polycaprolactone layer, and
a layer of a polymer blend formed of any combination of above polymers.

12. The pod according to claim 10, wherein the multilayer paper material comprises an additional layer, the additional layer selected from the group consisting of:
a polyvinyl-alcohol copolymer (PVOH) layer,
a polyglycolic acid (PGA) layer,
a metallization coating,
a SiOₓ based coating,
an AlOₓ based coating, and
a combination thereof.

13. The pod according to claim 10, wherein the additional layer is a plastic polymer, and the layer of plastic comprises the additional layer positioned between two external layers selected from the group consisting of films of polylactic acid (PLA), polybutylene succinate (PBS), polyhydroxyalkanoates (PHA), polybutylene adipate terephthalate (PBTA), starch, and any film of a polymer blend formed of any combination of the polymers.

14. The pod according to claim 10, wherein the protective layer is a film comprising regenerated cellulose.

15. The pod according to claim 10, wherein the beverage ingredient contained in the pod is roast and ground coffee.

16. The pod according to claim 10, wherein:
the first pod enclosing part is a pod body, the pod body comprising a side wall and a bottom wall defining the chamber and a circumferential annular body flange, the pod body containing the beverage ingredient, and
the second pod enclosing part is a top lid attached to the circumferential flange, the top lid closing a top opening of the pod body.

17. The pod according to claim 10, wherein:
each of the first and second pod enclosing parts is a pod body, the pod body comprising a side wall and a bottom wall defining half of the chamber and a circumferential annular body flange, and
the circumferential annular body flanges of the pod bodies are attached together,
wherein in each of the first and the second pod enclosing parts, the external surface of the multilayer paper material of the pod enclosing part is covered by a protective layer,
wherein the external surface of the protective layer presents a surface tension inferior to 40 dyne/cm.

18. The pod according to claim 10, wherein the surface tension of the external surface of the protective layer is inferior to 36 dyne/cm.

19. The system according to claim 1, wherein the surface tension of the external surface of the protective layer is inferior to 36 dyne/cm.
